(19) United States
(12) Patent Application Publication
(10) Pub. No.: US 2006/0156614 A1
(43) Pub. Date: Jul. 20, 2006

(54) Horizontal unilateral fish hooks

(76) Inventor: Frank T. Brzozowski, (US)

Correspondence Address: FRANK T. BRZOZOWSKI, 2357 E. Dauphin Street, Philadelphia, PA, 19125, US

(21) Appl. No.: 11/384,093

(22) Filed: Mar. 17, 2006

Related U.S. Application Data
(63) Continuation-in-part of application No. 10/724,859, filed on Nov. 30, 2003.
(60) Provisional application No. 60/430,325, filed on Nov. 30, 2002.

(51) Int. Cl. A01K 83/00

(52) U.S. Cl. 43/44.82; 43/43.16; 43/43.15

(57) ABSTRACT

A horizontal unilateral fishing hook 41 is a one piece unit intended to lie flat; it consists of an eye that connects to the fishing line, a solidly joined shank 42 that bends vertically towards the eye 43, a vertically oriented eye 43 and shank 42 in the same plane as a vertical center hook barb 45, and a symmetrical pair of outer hook barbs 44 which are disposed within a 180° section; this placement of the barbs acts as a guard against debris and the hook flips upright when the leader is being reeled. Horizontal unilateral fishing hooks have variations: 2-prong hook, 3-prong hooks, and forked 3-prong hooks, with center prongs that are equal, longer and shorter than the outer prongs. Each of the hooks are made of durable material or metal, and shanks formed by combining 2 or 3 prongs with a liquid means that hardens solid.

### CROSS REFERENCE TO RELATED APPLICATIONS

| Country -Number | MM-YYYY | Name Classification |
|---|---|---|
| U.S. Patent Documents | | |
| U.S. Pat. No. 6,770,295 | 08-2004 | Davidson, Lawrence P. 43/43.16 |
| U.S. Pat. No. 6,739,085 | 05-2004 | Burczynski, Michael J. 43/43.16 43/43.4 |
| U.S. Pat. No. 6,691,449 | 02-2004 | Hoben, Donald M 43/43.16, 434/43.2 |
| U.S. Pat. No. 6,655,075 | 12-2003 | Bohn, Greg 43/43.6 |
| U.S. Pat. No. 6,640,489 | 11-2003 | Rigney, Jan J. 43/42.37 |
| U.S. Pat. No. 6,560,917 | 05-3002 | Van Der Hoven, et al 43/43.4, 43/43.16, 43/37 |
| U.S. Pat. No. 6,526,690 | 03-2003 | Dillard, Michael C. 43/4, 269/907 |
| U.S. Pat. No. 6,519,895 | 02-2003 | Bennett, Thomas J. 43/44.81 43/42.39, 43/43.16 |
| U.S. Pat. No. 6,497,068B1 | 12-2002 | Lemons, John D. 43/36 |
| U.S. Pat. No. 6,325,136 | 12-2001 | Ratte, Geoffrey S. 164/129, 164/131 |
| U.S. Pat. No. 6,305,121 | 11-2000 | Adams, Nicholas S. 43/44.96, 43/43.1 |
| U.S. Pat. No. 6,170,191 | 01-2001 | Laney, Scot H. 43/43.13 43/44.9 |
| U.S. Pat. No. 6,145,240 | 06-1999 | Adams, Nicholas S. 43/44.96 |
| U.S. Pat. No. 6,076,297 | 06-2000 | Lippincott, Robert 43/44.87, 43/44.91 |
| U.S. Pat. No. 6,073,386 | 06-2000 | Firmin, Herman P. 43/44.87, 43/44.9 |
| U.S. Pat. No. 6,067,942 | 05-2000 | Fernandez, John Barnard, 119/802 |
| U.S. Pat. No. 6,047,493 | 04-2000 | Strampe, Clarence W. 43/44.96, 43/44.97, 43/44.87 |
| U.S. Pat. No. 5,946,849 | 09-1999 | Brown, John E. 43/44.89 43/43.1 |
| U.S. Pat. No. 5,918,408 | 07-1999 | Laney, Scot H. 43/43.13 43/44.9 |
| U.S. Pat. No. 5,887,381 | 03-1999 | Stephenson, Timothy L. 43/43.15 |
| U.S. Pat. No. 5,878,525 | 03-1999 | Metzler, Norman P. 43/43.1, 43/44.94 |
| U.S. Pat. No. 5,752,961 | 05-1998 | Hill, Bradley B. 606/113 606/110 |
| U.S. Pat. No. 5,678,351 | 10-1997 | Halterman, Jr., Danny R. 43/43.1 |
| U.S. Pat. No. 5,673,508 | 10-1997 | Snyder, Gary 43/42.37, 43/44.8, 43/44.82 |
| U.S. Pat. No. 5,386,660 | 02-1995 | Levin, John M. 43/43.16 43/44.82 |
| U.S. Pat. No. 4,914,852 | 04-1990 | Hnizdor, Thomas A 43/44.82 |
| U.S. Pat. No. 4,785,509 | 11-1988 | Fisher, Sidney L.; 24/129R |
| U.S. Pat. No. 4,696,125 | 09-1987 | Raybum, Walter 43/43.14 |
| U.S. Pat. No. 4,209,933 | 07-1980 | Manno, Joseph T. 43/43.15 |
| U.S. Pat. No. 3,701,212 | 10-1972 | Gilliam, Joe L. 43/44.87 |
| U.S. Pat. No. 3,118,245 | 01-1964 | Shriver, Lloyd L. 43/43.15 |
| U.S. Pat. No. 3,096,599 | 07-1963 | Baron, Charles 43/44.9 |
| U.S. Pat. No. 2,766.549 | 10-1956 | Dickerson, William 43/44.98 |
| U.S. Pat. No. 2,703,947 | 03-1955 | Petrasek et. al. 43/42.39 |
| U.S. Pat. No. 2,177,007 | 10-1939 | Smith, Wallace E. 43/44.88 |
| U.S. Pat. No. 2,019,630 | 11-1935 | Peeso, Martin E. 43/43.11 |
| U.S. Pat. No. 1,883,574 | 10-1932 | Cleeland, John S. 43/43.1 |
| U.S. Pat. No. 1,208,936 | 12-1916 | England, Henry 43/43.1 |
| U.S. Pat. No. 10/724,859 | 03-2006 | Brzozowski, Frank T. 43/43.15 |
| D469,502 S | 01-2003 | Shelton, Billy R. |
| D458,982 S | 06-2002 | Ratte, Geoffrey S. D22/145 |
| Foreign Patent Documents | | |
| PCT/US2003/038034 | 11-2003 | Brzozowski |
| Canada No. US2003038034 | 05-2005 | Brzozowski |
| Australia No. 2003298750 | 06-2005 | Brzozowski |
| New Zealand No. 5450975 | 06-2005 | Brzozowski |
| EPO No. 03796508.4-2321 | 06-2005 | Brzozowski |

| Publications | |
|---|---|
| PCT Publication No.: | WO 2004/049788 A3 |
| US Publication No.: | US 2004/0107629 A1 Jun. 10, 2004 |

| | | |
|---|---|---|
| PCT Publication No.: | WO 2004/049788 A3 | |
| US Publication No.: | US 2004/0107629 A1 | Jun. 10, 2004 |

### OTHER REFERENCES

Bass Pro Shops®, Bass Pro Outdoors Online LLC, www.basspro.com
Cabela's® Master Catalog, Cabela's Inc., www.cabelas.com
Luckey, Carl F, and Harbin, Clyde, Sr., “Warman's® Fishing Lures Field Guide,” ISBN 0-87349-692-2 Kraus Publication Inc.,© 2003,
Pfeiffer, C. Boyd. “The Field and Stream Baits and Rigs Handbook,” ISBN 1-55821-883-1, The Lyons Press © 01999.

### PARENT CASE TEXT AND RELATED APPLICATIONS

This application, the “Horizontal Unilateral Fish Hooks,” is also related to a continuation-in-part patent application about to be filed, under the title of “Bottom Fish Rig with Single Hook” and is related to a continuation-in-part patent application filed on Mar. 10, 2006, under the title of “Sliding C-weight;” this application is a continuation-in-part of U.S. patent application Ser. No. 10/724,859 filed on Nov. 30, 2003, entitled “Bottom Fish Rig:” The entire contents of the parent application is incorporated herein by reference. This application incorporates and is based on provisional application No. 60/430,325, filed on Nov. 30, 2002 which cited the Document Disclosure Deposit Request No. 504577 filed on Jan. 28, 2002; the entire contents of which are incorporated by reference.

### BACKGROUND OF THE INVENTION

1. Field of the Invention

The parent patent, the bottom fish rig, has a strong leader with a notable new horizontal unilateral fish hook that resists snagging and reduces possible injuries. The present invention is useful, new and has particular utility in connection with fishing tackle by having appearance and features different from other fishing tackle, such as commercial treble hooks, double hooks and other combination hooks.

In the present invention horizontal unilateral fish hooks have various embodiments: horizontal 3-prong fish hooks and an embodiment with two-prong hooks. Predominate scope of the horizontal unilateral fish hooks patent will focus upon the horizontal unilateral 3-prong hooks, whose hooks are solidly joined together at the shank. In comparison to the commercial treble hook, a horizontal unilateral fish hook's appearance, shape, and simple mechanical function, are obvious features that are different. A treble hook stands vertically; a horizontal unilateral 3-prong hook is unable to stand vertical: it is off-balanced since the eye and shank are elevated toward the barb of the center hook, and a horizontal unilateral 3-prong hook has a tendency to fall onto its horizontal side. Conversely, when a treble hook lies horizontally on its side, two of its barbs have a tendency of catching and snagging objects. In contrast a horizontal unilateral 3-prong hook has barbs that are parallel to the surface and are resistant to snagging onto objects. When a leader with a horizontal unilateral 3-prong hook is jerked, the force pulls the eye and causes a horizontal unilateral 3-prong hook to flip upright. The design and construction of a horizontal unilateral 2-pronged hook has the same characteristics as the above described horizontal unilateral 3-prong hook, but without the center barb.

Therefore, a need exists for a new and improved bottom fish rig which can be used for fishing tackle having horizontal unilateral fish hooks that resists snagging. In this regard, the present embodiment of the invention substantially fulfills this need. Moreover, the bottom fish rig, according to the present embodiment of the present invention substantially departs from the conventional concepts and designs of the prior art, and in doing so provides an apparatus primarily developed for the purpose of fishing by having a horizontal unilateral fish hooks that lies upright horizontally on the bottom of a waterway and resists snagging.

2. Description of the Prior Art

Horizontal unilateral fish hooks could be used independently on a fishing line like a hook or made as a component of a fishing rig. A patent search, an investigation of bait stores, sporting goods stores, internet catalogues and fishing books did not find or reveal a horizontal unilateral fish hook. Horizontal unilateral fish hook are new, unique and performs differently from the usual fishing tackle that is used: double hooks, treble hooks, combination hooks and hooks in rigs.

In the prior art the patents displayed or illustrated do not have an embodiment like a horizontal unilateral fish hook. Patents for single fish hooks were not individually examined since the present invention is unlike any single fish hook. However, single fish hooks appear to be numerous and it is amazing that patents have been issued for different hooks with subtle differences. Many types of single barb fishhooks exist; some of the manufactures are Mustad,® Eagle Claw,® Gamakatsu,® Matzuo Hooks, VMC,® Cabela's,® Bass Pro Shops® Extreme Performance Series XPS™, Bleeding Bait Hooks and King Kat™ Circle Hooks are currently available as well as products of many earlier fish hook manufacturers that have went out of business or were purchased by larger companies.

Presently, VMC manufactures at least 10 models of single hooks and 2 treble hooks. Matzuo Hooks is a company that manufactures at least 11 single hooks and 3 treble hooks. Bleeding Bait Hooks is a company that has different models of single hooks: Offset Worm Hook, Fatgap™ Tube Hook, Offset—wide gap, Copperhead 60°, Drop Shot Hook and Wacky Hook™.

Gamakatsu,® manufactures many models of single hooks: Octopus—bronze, nickel, green and red, Offset Shank EWG, Split Shot Hook, Walleye Wide Gap, Round Bend Worm, Weedless Worm Hook, Straight Eye Shiner, G-Lock Worm Hook, Jig Hook 90°, Offset Worm Hook, Offset Round Bend, Open Eye Siwash, G. Stinger, 60° Flat Eye jig, 90° Jig—Heavy wire, Octopus Circle, G-mag Worm, and Superline Worm Hooks.

Eagle Claw® has many single hooks, Black Pearl Aberdeen, Salmon Egg Sliced shank, Plain Shank, Bait holder, Baitholder—ringed eye, Aberdeen—plain shank ringed eye, Extra light Aberdeen, Aberdeen extradite wire , O'Shaughnessy x-strong stainless steel, Weedless, Lazer Sharp® Jig Hook red, Aberdeen Jig Hook—90,° Lazer Sharp® Salmon Egg Baitholder, Lazer Sharp Wide Bend—Extra-wide gap, Lazer Sharp* Teflon light wire, Lazer Sharp® Khale Ring eye, Lazer Sharp® Khale Horizontal—wide open gap upturned eye, Lazer Sharps Steelhead—upturned eye, Lazer Sharp® Salmon/Steelhead red, Lazer Sharp® Octopus style, and Lazer Sharp® Snelled Salmon Red.

Advancing beyond the crowded art of the single hooks, the double hooks and treble hooks are items of interest. The horizontal unilateral fish hooks have characteristics that are novel and new in comparison to the double and treble hooks available presently. The artwork and functions of the horizontal unilateral fish hooks are different from the hooks in the prior art. F. C. Woods patented detachable double and treble hooks which resemble the common treble hooks, but with a space between two shanks. Most of the treble hooks look similar with slight differences. Some of the treble hooks found are: Eagle Claw® manufactures a Lazer Sharp® Treble red, Treble—Hollow ground points brazed, and Lazer Sharp Treble—hollow ground point; Gamakatsu manufactures an Extra-Wide Gap Treble and Round Bend Treble; Matzuo manufactures model BE-11-8515, BE-11-8529, and a weedless treble hook BE-11-8514; VMC makes Model 9617GO and 9617BZ. Most patents for treble hooks and double fish hooks were not individually examined since the present invention is unlike any of those fish hooks. The new horizontal unilateral fish hooks are designed to stay elevated as it drops horizontally on the bottom of a waterway with bait, due to a novel placement of the fish hook eye and weight of the shank.

The double hooks of some interest are the VMC 9508 double hook, and the Gamakatsu Frog Hook which are not welded and are predominately used as a replacement hook in lures. The two double hooks seem to have two independent shanks, while the horizontal unilateral fish hook has the shanks solidly joined together. A horizontal unilateral fish hook is designed to lie horizontally on the floor of a body of water. When the fishing line is jerked, the force toward the eye causes a horizontal unilateral fish hook to flip upright; however, when baited, the VMC, Gamakatsu® frog hook and similar double hooks become top heavy land on the bottom of waterways upside down; their barbs could snag onto objects. Another difference is the location of the eye. In the VMC, Gamakatsu® and other double hooks, the eye is in the same plane as the shank; in contrast to the horizontal unilateral fish hook whose eye is designed to be elevated by the solidly joined and slanted shank.

Another double hook that relates to this invention is the Mustad® Double Live Bait Hook which has a bendable pin between the barbs of the double hook that extends the length of the hook to slightly beyond the eye. The double live bait hook has a safety pin latch at the base of the eye that holds the point of the pin at one end and the shanks of the two double hooks are connected to the other end of the pin. In the prior art, the Mustad® Double Live Bait Hook is very similar to a component of the patent issued to Shriver in 1962.

The bait positioning fishing device U.S. Pat. No. 3,118,245 was issued to Shriver. The artwork looks like a large cross with long thin rods, a sinker is attached at one end to a rod and fish hooks soldered to the same rod at the other end. Both the Shriver patent and the Mustad® Double Live Bait hook have latch a distance away from the barbs that secures bait with a pin or rod. Although Shrivers' patent has two hooks soldered to a rod, the invention has many components that are different than the horizontal unilateral fish hook which is more compact, has a different appearance and is designed to resist snagging. A disadvantage of the Shriver patent, the Mustad® Double Live Bait Hook and the Gamakatsu® frog hook is that once bait is inserted upon the hooks, the combination could become top-heavy and the barbs of the hooks could actually be pointing downward and become snagged onto objects.

This disadvantage might also occur to the Automatic fishhook by Lemons, U.S. Pat. No. 6,497,068 which is a one piece double hook that has two legs that have barbs connected to a torsion spring that resembles a spring with 2 fishing hooks on the ends; Lemons' patent does not resemble the fishing hooks in stores nor does it resemble a horizontal unilateral fish hook.

The use of fishing hooks and devices are known in the prior art. For example, U.S. Pat. No. 4,914,852 to Hnizdor discloses a tandem double offset fishhook includes first and second hooks, each having a shank, an offset bend curving concavely from one end of the shank and a point at the end of the bend. The shank of one of the first and second hooks is longer than the other shank with respect to the eye formed at one end of one of the shanks so as to space the points of the first and second shanks apart. The offset bends of the first and second hooks are disposed at equal inverted angles on opposite sides of a vertical plane through the first and second shanks generate forces which cause the fishhook to rotate and spin as it is drawn through the water while being reeled in. In one embodiment, the first and second shanks are integrally formed from a single elongated wire, with the eye disposed between the ends of the shank at one end and the shanks being disposed side-by-side in parallel. In another embodiment, the shank of one hook is rigidly connected to the shank of the other hook adjacent the bend of the other hook to form a co-linear extension of the other hook. However, the Hnizdor '852 patent is obviously different than a horizontal unilateral fish hook that is elevated and resists snagging.

Similarly, U.S. Pat. No. 2,703,947 to Petrasek discloses a fish lure comprising a concavo-convex spoon member with slightly upwardly curved sides. The spoon member is substantially tear-drop shaped in outline and has a substantially rounded front end and an elongated tail end. The spoon member has an elongated depression formed therein and is located centrally and symmetrically to the longitudinal axis thereof. A readily removable elongated weight member is located within the depression. A first screw connects the weight member to the spoon. A hook member comprises a shank extending in a continuation of the longitudinal axis, and has an end extending through an opening formed in the tail end. At least one hook, on the other end of the shank, and another screw connects the first mentioned end of the shank to the spoon. The first screw associates the spoon member with weights having different masses. However, the Petrasek '947 patent does not have a hook with features of a horizontal unilateral fish hook that is designed to resists snagging.

Additionally, U.S. Pat. No. 5,022,178 to Carlson, discloses a fishing rig for live or artificial bait with a bendable member mounted between at least two hooks, particularly treble hooks; the hooks being mounted with respect to a leader such that when one hook is set in a fish, the bendable member bends upon a pull of the leader and the other hook moves toward the set hook. The bending of the bendable member forces the other hook into a set condition and enlarges the transverse width of the rig within the fish so that a double hooking action is guaranteed. However, the Carlson '178 patent has a different mechanical function and is unlike a horizontal unilateral fish hook that resists snagging.

Further, U.S. Pat. No. 4,888,910 to Lewis discloses an adjustable snelled hook assembly comprises a fishing line with a trailing hook secured thereto. An auxiliary hook has a shank, a barb and an eye loosely and slidably mounted upon the fishing line adjustably spaced from the trailing hook. A coil spring is mounted upon the shank and is generally parallel to the fishing line. A plurality of continuous windings of the line extend around, and snugly engage, the spring and shank to anchor the auxiliary hook upon the fishing line. However, the Lewis '910 patent does not have a horizontal unilateral fish hook that resists snagging.

Yet further, U.S. Pat. No. 5,673,508 to Snyder discloses a beaded fishing lure having a weighted body molded to a fish hook and including a beaded trailer hook. A flapper piece oscillates with lure movement about a projecting extension of the hook shank to strike the body and produce audible sound. The flapper is secured to the body with a split ring at aligned apertures and from a slot which mounts about the hook extension. The eye of the trailer hook is secured to the shank of the primary hook and a bead is molded to the trailer hook. A variety of dressings mount to the bead including multi-filament skirts and molded plastic tails. However, the Snyder '508 patent does not have a horizontal unilateral hook that resists snagging.

Lastly, U.S. Pat. No. 5,386,660 to Levin discloses a fishing hook with curved barb that is resistant to accidental dislodgement from the mouth of a fish, yet which does not pose a snagging hazard to persons handling it. The hook comprises a shank portion, at least one bent return portion, and a barb at the upper end of the return portion. The return portion of the hook has a longitudinal axis which is generally parallel to the longitudinal axis of the shank. The barb terminates in a sharply pointed free end contiguous with a generally semi-tear-drop shaped, relatively blunt, edge surface. That edge surface includes a curved portion spaced laterally of the longitudinal axis of the return portion of the hook and a contiguous undercut portion merging with the return portion of the hook. The curved portion of the edge surface may be directed toward or away from the shank of the hook. However, the Levin '660 patent does not have a horizontal unilateral fish hook that resists snagging.

While the above-described devices fulfill their respective, particular objectives and requirements, the aforementioned patents do not describe an invention that functions and is shaped like the horizontal unilateral fish hook, which is basically more compact, simple to apply in the field, and to manufacture. Beside the prior art and aforementioned patents, the present invention has components that are nonobvious, novel, useful, and an improvement over other inventions in the field. A horizontal unilateral fish hook is novel by itself individually and when used as a component in the parent invention, the bottom fish rig.

### SUMMARY OF THE INVENTION

The bottom fish rig, which is the parent patent, has a horizontal unilateral 3-prong hook as a component of the invention. A preferred embodiment is a horizontal unilateral 3-prong hook, whose appearance and features different from other fishing tackle, such as commercial treble hooks, and other combination hooks. In the parent invention a horizontal unilateral 3-prong hook is quickly attached and removed by opening and closing the snap and swivel which runs through the eye of the a horizontal unilateral 3-prong hook. A treble hook stands vertically; but, a horizontal unilateral 3-prong hook is unable to stand vertically: it is off-balanced. The eye and shank are bent toward the barb of the middle hook, and a horizontal unilateral 3-prong hook has a tendency to fall onto its horizontal side. Conversely, when a treble hook lies horizontally on its side, two of its barbs have a tendency of catching and snagging objects. In contrast a horizontal unilateral fish hook has an elevated eye, solidly joined shank that adds weight to assist in falling, and barbs that are parallel to the surface, as a combination, are resistant to snagging onto objects. When the leader of a horizontal unilateral fish hook is jerked, the force toward the eye causes a horizontal unilateral fish hook to flip upright.

In view of the foregoing disadvantages inherent in the known types of fishing tackle now present in the prior art, the present embodiment of the invention provides an improved horizontal unilateral fish hook, and overcomes the above-mentioned disadvantages and drawbacks of the prior art. As such, the general purpose of the present embodiment of the invention, which will be described subsequently in greater detail, is to provide a new and improved horizontal unilateral fish hook, individually, and as a component of a bottom fish rig, which has all the advantages of the prior art mentioned heretofore and many novel features that result in a horizontal unilateral fish hook which is not anticipated, rendered obvious, suggested, or even implied by the prior art, either alone or in any combination thereof.

The prior art of record neither discloses nor fairly teaches the recited limitations of the claimed combination including, but not limited to a c-weight, individually, or as a component of the parent patent, the bottom fish rig.

There has thus been outlined, rather broadly, the more important features of the embodiment of the invention in order that the detailed description thereof that follows may be better understood and in order that the present contribution to the art may be better appreciated. There are, of course, additional features of the present embodiment of the invention that will be described hereinafter and which will form the subject matter of the claims attached.

Numerous objects, features and advantages of the present embodiment of the invention will be readily apparent to those of ordinary skill in the art upon a reading of the following detailed description of presently preferred, but nonetheless illustrative, embodiments of the present embodiment of the invention when taken in conjunction with the accompanying drawings. In this respect, before explaining the current embodiment of the embodiment of the invention in detail, it is to be understood that the embodiment of the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present embodiment of the invention.

Objects and Advantages

It is therefore an object of the present embodiment of the invention to provide a new and improved horizontal unilateral fish hook that has all of the advantages of the prior art fishing tackle and none of the disadvantages.

It is another object of the present embodiment of the invention to provide a new and improved horizontal unilateral fish hook that may be easily and efficiently manufactured and marketed.

An even further object of the present embodiment of the invention is to provide a new and improved horizontal unilateral fish hook that has a low cost of manufacture with regard to both materials and labor, and which accordingly is then susceptible of low prices of sale to the consuming public, thereby making such horizontal unilateral fish hook economically available to the buying public.

Still another object of the present embodiment of the invention is to provide a new horizontal unilateral fish hook that provides in the apparatuses and methods of the prior art, some of the advantages thereof, while simultaneously overcoming some of the disadvantages normally associated therewith.

Another object of the present embodiment of the horizontal unilateral fish hook is its novel features, consisting of attributes that most other fishing hooks do not possess; it orients itself upright and resists snagging.

Yet another object of the horizontal unilateral fish hook is to be used independently on a fishing line or made as a component of a fishing rig.

An object of the present invention is to provide a useful and unique fish hook with at least two unilateral outer barbs that are arched or angled, thus causing the horizontal unilateral fish hook to slide upright and avoid snags while being used.

Another object of the present invention is to construct a horizontal unilateral fish hook with barbs that lie parallel to the bottom of a waterway or ground, if someone steps upon the hook, the barbs will flatten and collapse, and the hook avoids sticking into the person's shoe.

Another object of the horizontal unilateral fish hook in this invention is to be easily installed without any tool, and when it is used with a snap and swivel it can be attached and removed from the fishing line quicker than the common fishing hooks without cutting the fishing line or the leader to which it is attached.

Another object of the present invention is to create a strong hook made of various metals or alloys, including but not limited to iron, tungsten, zinc plating, or stainless steel compounds.

Even still another object of the present embodiment of the invention is to provide a horizontal unilateral fish hook for fishing tackle having 2 or 3 barbs and the option of being constructed of various metals or alloys that solidly join the shank and weighted hooks are constructed with additional metal that expanded the thickness of the shank.

Lastly, embodiments with 2 prong hooks or 3-prong hooks could be made as a horizontal unilateral fish hook which has various sizes, shapes and styles and is still another object of the present embodiment of the invention.

These together with other objects of the embodiment of the invention, along with the various features of novelty that characterize the embodiment of the invention, are pointed out with particularity in the claims annexed to and forming a part of this disclosure. For a better understanding of the embodiment of the invention, its operating advantages and the specific objects attained by its uses, reference should be made to the accompanying drawings and descriptive matter in which there are illustrations of the preferred embodiments of the invention.

### BRIEF DESCRIPTION OF THE DRAWINGS

The embodiment of the invention will be better understood and objects other than those set forth above will become apparent when consideration is given to the following detailed description thereof. Such description makes reference to the annexed drawings wherein:

FIG. 1 is a top perspective view of the preferred embodiment of a bottom fish rig constructed in accordance with the principles of the present invention, a horizontal unilateral fish hook.

FIG. 2 is a front view of a cross section of a horizontal unilateral fish hook of the present embodiment of the invention.

FIG. 3 is a top side perspective view of a horizontal unilateral fish hook of the second embodiment of the invention.

FIG. 4 is a side view of a third embodiment of a horizontal unilateral fish hook of the present invention.

FIG. 5 is a top view of a third embodiment of a horizontal unilateral fish hook of the invention.

FIG. 6 is a top perspective view of a third embodiment of a horizontal unilateral fish hook of the invention.

FIG. 7 is a top perspective view of a fourth embodiment of a horizontal unilateral fish hook of the invention.

FIG. 8 is a top view of a fourth embodiment of the horizontal unilateral fish hook of the invention.

FIG. 9 is a side view of the fourth embodiment of horizontal unilateral fish hook of the invention.

FIG. 10 is a side view of a fifth embodiment of horizontal unilateral fish hook of the invention.

FIG. 11 is top view of a fifth embodiment of horizontal unilateral fish hook of the invention.

FIG. 12 is a top perspective side view of a fifth embodiment of horizontal unilateral fish hook of the invention.

FIG. 13 is a top view of the sixth embodiment of the horizontal unilateral fish hook of the invention.

FIG. 14 is a top perspective view of the sixth embodiment of the horizontal unilateral fish hook of the invention

FIG. 15 is a side view of the sixth embodiment of the horizontal unilateral fish hook of the invention

The same reference numerals refer to the same parts throughout the various figures.

### DETAILED DESCRIPTION OF THE INVENTION

The horizontal unilateral fish hook is a one piece unit consisting of an eye or eyelet, a shank and 2-prong and 3-prong embodiments. The prong is a component of the horizontal unilateral fish hook from the tip of the point of the barb through the single shank to the area where at least two shanks are solidly joined as one large shank. The prong consists of a single shank, the bend of the metal to the barb, the barb and the sharp point at the tip. The gape is length from the tip of the barb to the shank; the bite is the length of the tip of the barb to the bend. The center hook barb is the area of the gape, the bite, the bend, the posterior end of a single shank and the barb to the point of the middle prong of the 3-prong hook. The outer hook barb is the is the area of the gape, the bite, the bend, the posterior end of a single shank and the barb to the point of the unilateral two outer prongs of the 3-prong hook and 2-prong hooks.

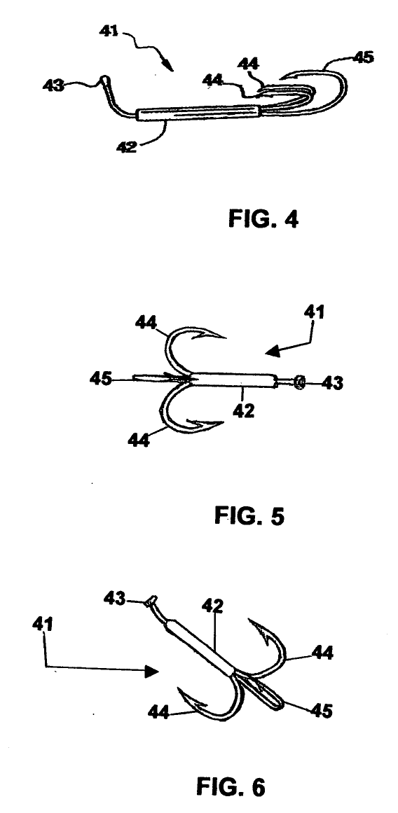

Referring now to drawings and particularly to FIGS. 4-12, preferred embodiments of the horizontal unilateral fish hook of the present invention are shown and generally designated by the reference numeral 41.

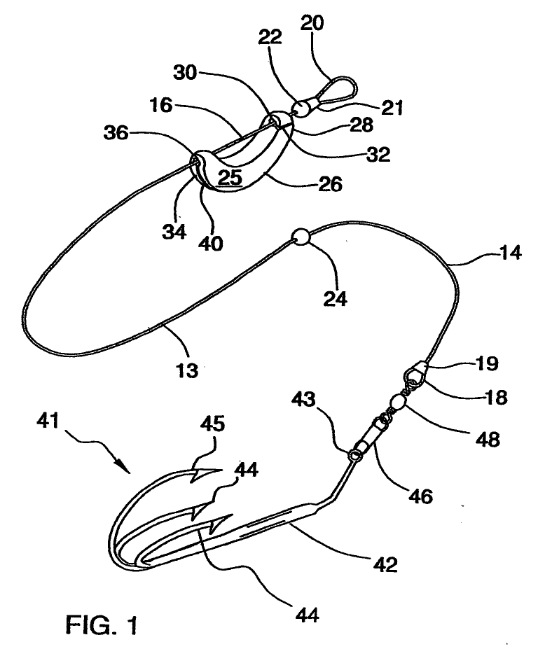

In the parent patent, FIG. 1 has a new and improved horizontal unilateral fish hook 41 attached to a bottom fish rig 12. FIGS. 4 to 15 describe different horizontal unilateral fish hooks 41 which could also be utilized independently without a rig.

In FIG. 1 a horizontal unilateral fish hook 41 is connected to a snap 46 and a swivel 48 that are attached to a leader 13. This allows the hook to be inserted and removed quickly. A horizontal unilateral three-pronged hook 41 has three solidly joined barbs, a center barb 45 and a pair of symmetrical outer barbs 44 which are disposed within the 180 degree section. The center hook barb 45 stands erect in the same plane as the shank 42 and eye 43. This upward and inward placement of outer barbs 44 allows the horizontal unilateral three-pronged hook 41 to slide upon the lake bottom without being caught on debris. The first embodiment has a longer arched shank to the eye than the proceeding embodiments.

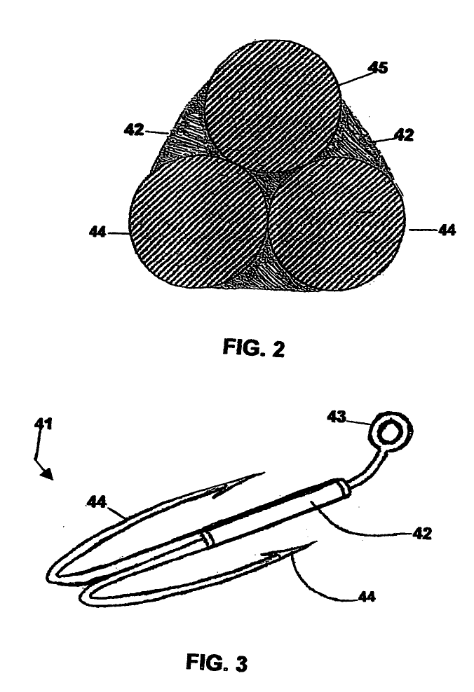

FIG. 2 is a cross section of the shank of a horizontal unilateral fish hook 41. The center barb 45 and a pair of symmetrical outer barbs 44 of the shank 42 are solidly joined together. The larger diameter is caused by welding shanks together or due to silver solder, lead-tin solder, or a tungsten to add additional weight to the hook.

FIG. 3 is a second embodiment of the horizontal unilateral fish hook 41. This is a 2-prong horizontal unilateral fish hook 41 hook whose shanks are solidly joined together. The two outer barbs 44 are elevated as well as the shank 42 and eye 43 which is elevated above the center of the two joined shanks. Two outer barbs 44 are spread away from the shank with a “V” shaped middle area in which bait could be attached; and two symmetrical outer hook barbs 44 are angularly symmetrical about the longitudinal axes of the elevated shank 42 and eye 43. This type of hook 41 if soldered would take more solder circumscribing around the length of the shank 42 to give it a wider and heavier appearance and assist in falling flat.

FIG. 4 to FIG. 6 illustrate a third embodiment, which has a longer center hook 45 that the two outer hooks 44 making a “M” shape area. In FIG. 4, a horizontal unilateral three-pronged hook 41 of the bottom fish rig 12 is illustrated and will be described. A horizontal unilateral three-pronged hook 41 has a longer vertical center hook barb 45 and a pair of symmetrical outer hook barbs 44 which are located within the 180 degree section. The eye 43 is elevated to a height comparable to the height of the vertical center barb 45. This upward and inward placement of the barbs 44 allows the horizontal unilateral three-pronged hook 41 to slide without snagging and to flip upright as the leader is being reeled.

In FIG. 5 a horizontal unilateral three-pronged hook 41 has a longer vertical center hook barb 45 and a pair of symmetrical outer hook barbs 44. The eye 43 is elevated to a height comparable to the height of the vertical center barb 45 and both are in the same vertical plane.

In FIG. 6 a horizontal unilateral three-pronged hook 41 has a longer vertical center hook barb 45 and a pair of symmetrical outer hook barbs 44. The shank 42 is solidly joined together with shanks 42 of the inner 45 and outer barbs 44. The eye 43 is elevated and in the same vertical plane as the middle vertical center hook barb 45.

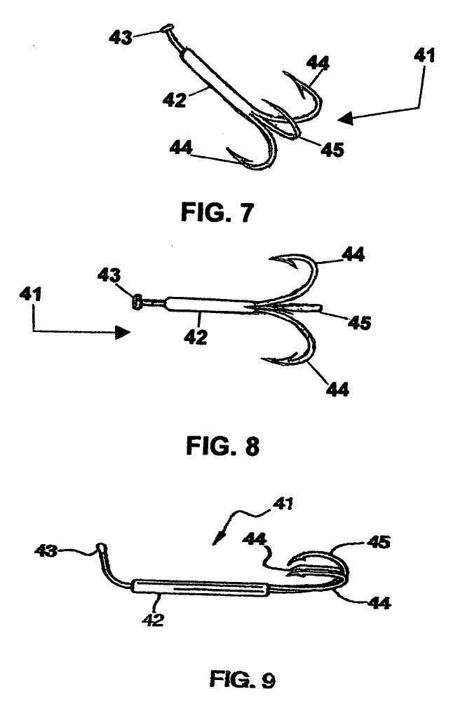

FIG. 7 to FIG. 9 illustrate a fourth embodiment, which has a center hook 45 that is equal to the length of the two outer hooks 44. In FIG. 7 a horizontal unilateral three-pronged hook 41 has a vertical center hook barb 45 and a pair of symmetrical outer hook barbs 44 that are equal in length. The eye 43 is elevated to a height comparable to the height of the vertical center barb 45 and both are in the same vertical plane.

In FIG. 8 a horizontal unilateral three-pronged hook 41 has a vertical center hook barb 45 and a pair of symmetrical outer hook barbs 44 that are equal in length. The shank 42 is solidly joined together with shanks 42 of the inner 45 and outer barbs 44. The eye 43 is elevated and in the same vertical plane as the middle vertical center hook barb 45.

In FIG. 9, a horizontal unilateral three-pronged hook 41 of the bottom fish rig 12 is illustrated and will be described. A horizontal unilateral three-pronged hook 41 has an equal vertical center hook barb 45 and a pair of symmetrical outer hook barbs 44 which are located within the 180 degree section. The eye 43 is elevated to a height comparable to the height of the vertical center barb 45. This upward and inward placement of the barbs 44 allows the horizontal unilateral three-pronged hook 41 to slide without snagging and to flip upright as the leader is being reeled.

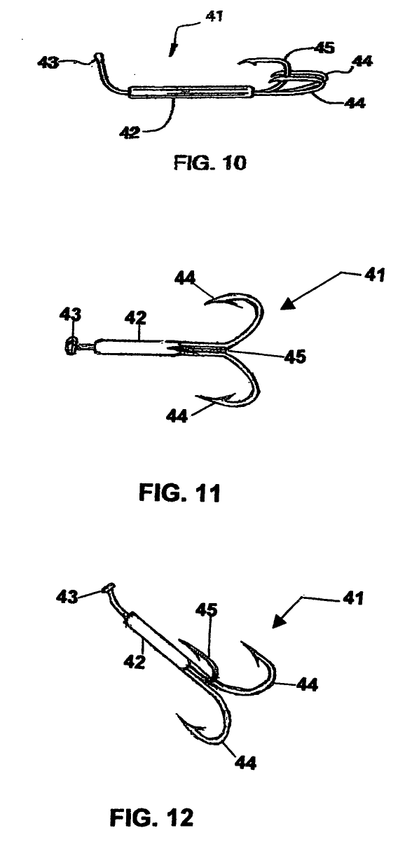

FIG. 10 to FIG. 12 illustrate a fifth embodiment, which has a shorter center hook 45 than the two outer hooks 44. In FIG. 10, a horizontal unilateral three-pronged hook 41 of the bottom fish rig 12 is illustrated and will be described. A horizontal unilateral three-pronged hook 41 has a shorter vertical center hook barb 45 and a pair of symmetrical outer hook barbs 44 which are located within the 180 degree section. The eye 43 is elevated to a height comparable to the height of the vertical center barb 45. This upward and inward placement of the barbs 44 allows the horizontal unilateral three-pronged hook 41 to slide without snagging and to flip upright as the leader is being reeled.

In FIG. 11 a horizontal unilateral three-pronged hook 41 has a shorter vertical center hook barb 45 and a pair of symmetrical outer hook barbs 44. The eye 43 is elevated to a height comparable to the height of the vertical center barb 45 and both are in the same vertical plane.

In FIG. 12 a horizontal unilateral three-pronged hook 41 has a shorter vertical center hook barb 45 and a pair of symmetrical outer hook barbs 44. The shank 42 is solidly joined together with shanks 42 of the inner 45 and outer barbs 44. The eye 43 is elevated and in the same vertical plane as the middle vertical center hook barb 45.

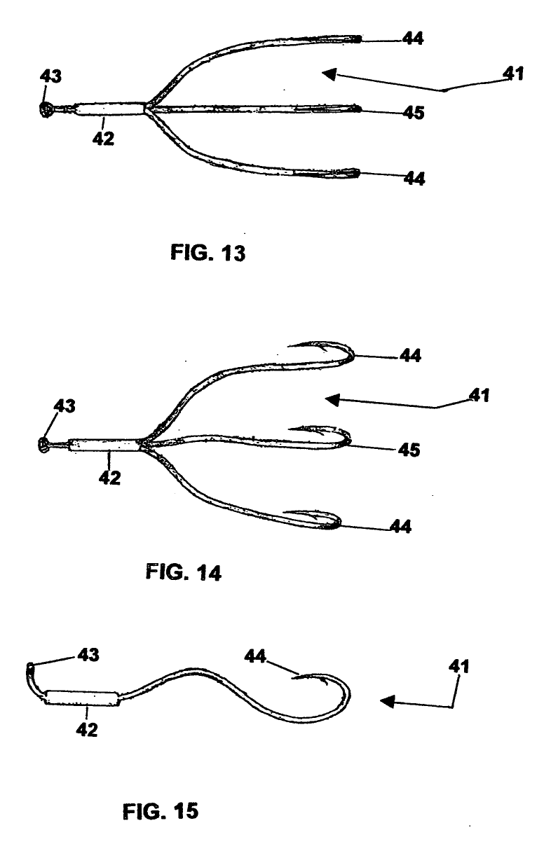

FIG. 13 to FIG. 15 illustrate a sixth embodiment, which has a center hook 45 that is about the same length as the two outer hooks 44. A forked horizontal unilateral three-pronged hook 41 used in FIGS. 13 to FIGS. 15 has larger and wider hooks with a smaller distance from the shank 42 to eye 43. Although the five previous embodiments that have long shanks are solidly joined together on a level horizontal plane, this embodiment has a shorter solidly joined shank; it has 3 long sine-wave shaped prongs extending to the barbs that is designed as a weed guard to deflect objects and hold more bait.

Forked horizontal unilateral three-pronged hooks 41 illustrated in FIG. 13 through FIG. 15 represent some of the different embodiments and styles that could be incorporated into structuring a horizontal unilateral three-pronged hook 41. In FIG. 13 a forked horizontal unilateral three-pronged hook 41 has a set of three solidly joined barbs, a vertical center hook barb 45 and a pair of two outer hook barbs 44 that are located within an upper 180-degree section. The center hook barb 45 stands erect in the same plane as the shank 42 and eye 43 which are bent upward from the horizontal position. This upward placement of the barbs 44 that are parallel to the bottom surface allows the horizontal unilateral three-pronged hook 41 to drag upon the bottom of the water without the prongs being caught on debris. A horizontal unilateral 3-prong hook 41 has a tendency to fall onto its horizontal side and flip upward when the leader 13 of a horizontal unilateral 3-prong hook 41 as in FIG. 1 is jerked, the force toward the eye 43 causes a horizontal unilateral 3-prong hook 41 to pull the eye upright.

In FIG. 14, a top perspective view of the sixth embodiment, a forked horizontal unilateral three-pronged hook 41 is illustrated and will be described. A horizontal unilateral three-pronged hook 41 has three equidistant barbs, a vertical center hook barb 45 and a pair of symmetrical outer hook barbs 44 which are disposed within the 180 degree section. As compared to FIG. 1 this embodiment has a shorter shank 42 and a smaller center hook barb 45 and smaller outer hook barbs 44. Thus significantly more bait could be inserted upon the three barbs in this embodiment. This widen trident shape is a means of placement of the barbs 44 that also allows the forked horizontal unilateral three-pronged hook 41 to slide without snagging.

In FIG. 15, a sixth embodiment, a forked horizontal unilateral three-pronged hook 41 is illustrated and will be described. A horizontal unilateral three-pronged hook 41 has a vertical center hook barb 45 and a pair of symmetrical outer hook barbs 44 that are equidistant in length. The eye 43 is elevated to about the same height of the middle center hook barb 45 which are disposed within the same vertical plane. The shank 42 of a horizontal unilateral fish hook 41 connecting to the three prongs appears curved. This upward and inward placement of the barbs 44 allows the forked horizontal unilateral three-pronged hook 41 deflects objects, the undulated prongs acts as a weed guard and allows the hook to slide without snagging. Although not illustrated, the forked horizontal unilateral three-pronged hook 41 could be made with a longer middle prong and another embodiment with a shorter barb in the middle prong.

The bottom fish rig, which is the parent patent, has a horizontal unilateral 3-prong hook as a component of the invention. A horizontal unilateral 3-prong hook has an appearance and features different from other fishing tackle, such as commercial treble hooks, and other combination hooks. In the present invention a horizontal unilateral 3-prong hook is quickly attached and removed by opening and closing the snap and swivel which runs through the eye of the a horizontal unilateral 3-prong hook. In comparison to the commercial treble hook, one obvious feature that is different is its appearance and shape. A treble hook stands vertically; a horizontal unilateral 3-prong hook is almost unable to stand vertically. It is off-balanced since the eye and shank are bent toward the barb of the middle hook, and a horizontal unilateral 3-prong hook has a tendency to fall onto its horizontal side. Conversely, when a treble hook lies horizontally on its side, two of its barbs have a tendency of catching and snagging objects. In contrast a horizontal unilateral fish hook has an elevated eye, solidly joined shank with barbs that are parallel to the surface and are resistant to snagging onto objects. When the leader of a horizontal unilateral fish hook is jerked, the force toward the eye causes a horizontal unilateral fish hook to flip upright. Another feature that is novel and useful in another embodiment of a horizontal unilateral fish hook is the barbs lie parallel to the bottom of a waterway or ground, if someone steps upon the hook, the barbs will flatten and collapse, and the hook avoids puncturing a person's shoe.

While embodiments in the drawings of the sliding c-weight have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present embodiment of the invention. For example, horizontal unilateral fish hooks having 2 or 3 barbs have the option of being constructed of various metals or alloys that solidly join the shank, and weighted horizontal vertical fish hooks are constructed with additional metal that expands the thickness of the shank to assist in falling flat. Also any suitable sturdy material could be a means of creating a strong hook is made of durable compound or metal including iron, tungsten, copper, nickel, silver, bismuth, aluminum, titanium, chrome, vanadium, cobalt, tin, brass, bronze, zinc plating, carbide, stainless steel or a combination of various metals and alloys. Molten metal into molds, hooks welded together, prongs soldered, epoxy and glue are some means of forming a solidly joined shank by combining 2 or 3 prongs with a liquid means that hardens solid. The horizontal three-pronged hook could be made into hooks of many sizes, shapes, and angles of the barbs, as well as but not limited to darts, plugs and other lures that may be used. Furthermore, a wide variety of hook sizes, different colored jigs and darts may be used with the bottom fish rig instead of the one described.

Notably, any person of ordinary skill in the pertinent art, science or area of the sport of fishing could make and use the invention without extensive experimentation and catch a fish. Therefore, the foregoing is considered as illustrative only of the principles of the embodiment of the invention. Further, since numerous modifications and changes will readily occur to those skilled in the art, it is not desired to limit the embodiment of the invention to the exact construction and operation shown and described, and accordingly, all suitable modifications and equivalents may be resorted to, falling within the scope of the embodiment of the invention.

What I claim as new is as follows:

1. A horizontal unilateral fishing hook comprising:
a horizontal unilateral 2-prong hook is a one piece unit intended to lie flat; it consists of an eye that connects to the fishing line, a solidly joined shank that bends vertically towards the eye, and at least two-prongs yielding a symmetrical pair of upright outer hook barbs which are disposed within a 180° section: this placement of the barbs causes the hook to lie horizontally and allows said hook to slide upon a lake bottom without being caught on debris and to flip upright when fishing line is being reeled.

2. A horizontal unilateral fishing hook of claim 1 wherein:
a means of forming a prong from a dependent hook that consists of a portion of a single shank, a bend of a hook, a gape area between a barb and shank, a barb, a point, and a bite area between a bend and a tip of a point;
a means of creating a strong hook is made of durable material or metal including iron, tungsten, copper, nickel, silver, bismuth, aluminum, titanium, chrome, vanadium, cobalt, tin, brass, bronze, zinc plating, carbide, stainless steel or a combination of various metals and alloys;
a means of forming a solidly joined shank by combining 2 prongs with a liquid means that hardens solid; and
a means of creating 2 unilateral prongs by branching outwardly and away from the end of a solidly joined shank.

3. A horizontal unilateral fishing hook of claim 1 wherein:
a means of creating a strong hook is made of durable material or metal including iron, tungsten, zinc plating, stainless steel or a combination of various metals and alloys, and aforesaid like;
a solidly joined shank is solidified by solder or solder like compounds;
and a means of joining the shank with a thick layer of solder or molten compounds that causes a weighted hook effect.

4. A horizontal unilateral fishing hook of claim 1 wherein:
an outer hook barb is the exterior section of a prong consisting of a posterior end of a single shank, a bend and the area of the gape, a barb, and a bite area between the bend and the tip of a point;
two outer barbs are solidly joined to create the shank;
two outer barbs are spread away from the shank with a “V” shaped middle area in which bait could be attached; and
two symmetrical outer hook barbs are angularly symmetrical about the longitudinal axes of the elevated shank and eye.

5. A horizontal unilateral fishing hook comprising:
a horizontal unilateral 3-prong hook is a one piece unit intended to lie horizontally; it consists of an eye that connects to the fishing line, a solidly joined shank that bends vertically towards the eye, and said shank being solidly joined with 3 prongs, consisting of a vertically oriented eye and shank in the same plane as a vertical center hook barb, and a symmetrical pair of outer hook barbs which are disposed within a 180° section, this placement of the barbs causes the hook to lie horizontally and allows said hook to slide upon a lake bottom without being caught on debris and to flip upright when the leader is being reeled.

6. A horizontal unilateral fishing hook of claim 5 wherein:
a means of forming a prong from a dependent hook that consists of a portion of a single shank, a bend of a hook, a gape area between a barb and shank, a barb, a point and a bite area between a bend and a tip of a point;
a means of creating a strong hook is made of durable material or metal including iron, tungsten, copper, nickel, silver, bismuth, aluminum, titanium, chrome, vanadium, cobalt, tin, brass, bronze, zinc plating, carbide, stainless steel or a combination of various metals and alloys;
a means of forming a solidly joined shank by combining 3 prongs with a liquid means that hardens solid; and
a means of creating 3 unilateral prongs by branching outwardly and away from the end of a solidly joined shank.

7. A horizontal unilateral fishing hook of claim 5 wherein:
a means of creating a strong hook is made of durable material or metal including iron, tungsten, zinc plating, stainless steel or a combination of various metals and alloys, and aforesaid like;
a solidly joined shank is solidified by solder or solder like compounds;
and a means of joining the shank with a thick layer of solder or molten compounds that causes a weighted hook effect.

8. A horizontal unilateral fishing hook of claim 5 wherein:
an outer hook barb is the exterior section of a prong consisting of a posterior end of a single shank, a bend and the area of the gape, a barb, and a bite area between the bend and the tip of a point;
a center hook barb is vertically upright in the same plane and height as the elevated shank and eye. two outer barbs and a center hook barb are solidly joined to create the shank;
two outer barbs and a center hook barb are spread away from the shank with a “M” shaped middle area in which bait could be attached; and
two symmetrical outer hook barbs are angularly symmetrical about the longitudinal axes of the elevated shank and eye.

9. A horizontal unilateral fishing hook of claim 5 wherein:
said horizontal unilateral three-pronged hook has three equidistant barbs, with a vertically bent eye and shank in the same plane as a vertical center hook barb.

10. A horizontal unilateral fishing hook of claim 5 wherein:
said horizontal unilateral three-pronged hook has a pair of symmetrical shorter outer hook barbs with a longer vertically bent eye and shank in the same plane as a vertical center hook barb.

11. A horizontal unilateral fishing hook of claim 5 wherein:
said horizontal unilateral three-pronged hook has a pair of symmetrical longer outer hook barbs with a shorter vertically bent eye and shank in the same plane as a vertical center hook barb.

12. A horizontal unilateral fishing hook comprising:
a forked horizontal unilateral 3-prong hook is a one piece unit intended to lie horizontally; it consists of an eye that connects to the fishing line, a solidly joined shank that bends vertically towards the eye, and said shank being solidly joined with 3 long prongs consisting of a vertical center hook barb and a symmetrical pair of outer hook barbs which are disposed within a 180° section, this placement of the barbs causes the hook to lay horizontally with a vertical undulation that has a wavelike shape with an upward and inward placement means of the barbs that allows the forked horizontal unilateral three-pronged hook to deflects objects, acts as a weed guard, and allows the hook to slide without snagging.

13. A horizontal unilateral fishing hook of claim 12 wherein:
a means of forming a prong from a dependent hook that consists of a portion of a single shank, a bend of a hook, a gape area between a barb and shank, a barb, a point, and a bite area between a bend and a tip of a point;
a means of creating a strong hook is made of durable material or metal including iron, tungsten, copper, nickel, silver, bismuth, aluminum titanium, chrome, vanadium, cobalt, tin, brass, bronze, zinc plating, carbide, stainless steel or a combination of various metals and alloys;
a means of forming a solidly joined shank by combining 3 prongs with a liquid means that hardens solid;
a means of creating a long center prong with a vertical undulation that stands upright in a plane with a eye and a shank; and
a means of creating 2 outer unilateral prongs by branching and curving outwardly and bending away from the end of a solidly joined shank.

14. A horizontal unilateral fishing hook of claim 12 wherein:
a means of creating a strong forked hook is made of durable material or metal including iron, tungsten, zinc plating, stainless steel or a combination of various metals and alloys, and aforesaid like;
a solidly joined shank is solidified by solder or solder like compounds;
and a means of joining the shank with a thick layer of solder or molten compounds that causes a weighted hook effect.

15. A horizontal unilateral fishing hook of claim 12 wherein:
said forked horizontal unilateral three-pronged hook has three equidistant barbs, with a vertically bent eye and shank in the same plane as a vertical center hook barb.

16. A horizontal unilateral fishing hook of claim 12 wherein:
said forked horizontal unilateral three-pronged hook has a pair of symmetrical shorter outer hook barbs with a longer vertically bent eye and shank in the same plane as a vertical center hook barb.

17. A horizontal unilateral fishing hook of claim 12 wherein:
said forked horizontal unilateral three-pronged hook has a pair of symmetrical longer outer hook barbs with a shorter vertically bent eye and shank in the same plane as a vertical center hook barb.
